(19) United States
(12) Patent Application Publication
(10) Pub. No.: US 2019/0046906 A1
(43) Pub. Date: Feb. 14, 2019

(54) SYSTEM AND METHOD FOR SEPARATING SOLIDS FROM LIQUID-SOLID SLURRIES

(71) Applicant: Delta DeWatering, LLC, South Portland, ME (US)

(72) Inventor: James Goodwin, South Portland, ME (US)

(73) Assignee: Delta DeWatering, LLC, South Portland, ME (US)

(21) Appl. No.: 16/077,379

(22) PCT Filed: Feb. 8, 2017
(86) PCT No.: PCT/US17/16986

§ 371 Date: Aug. 10, 2018

Related U.S. Application Data
(60) Provisional application No. 62/294,328, filed on Feb. 12, 2016.

(51) Int. Cl. B01D 29/94; B01D 29/35; B01D 29/82; B01D 29/52; C02F 11/12

(52) U.S. Cl. CPC B01D 29/94; B01D 29/35; B01D 2201/16; B01D 29/52; C02F 11/121; B01D 29/824

(57) ABSTRACT

A system for separating solids from a liquid-solid slurry includes a collection vessel configured to receive the liquid-solid slurry in first opening and discharge it through a second opening. There is a filter unit having a chamber with a plurality of apertures and a discharge port. There is a pump unit interconnected to the chamber of the at least one filter unit. One of the filter unit or the pump unit is in fluid communication with the second opening in the collection vessel and is configured to receive the liquid-solid slurry and it through the filter unit chamber, causing liquid from the liquid-solid slurry to flow through the apertures and the solids to be retained in the chamber of the filter unit. The pump unit includes a discharge device which is translatable through the chamber of the filter unit to force solids retained in the chamber toward the discharge port.

### CROSS-REFERENCE TO RELATED APPLICATIONS

This application is the U.S. National Stage Application of International Application No. PCT/US2017/016986, filed on Feb. 8, 2017, which claims benefit of priority of U.S. Provisional Patent Application 62/294,328 filed on Feb. 12, 2016, which are incorporated herein by reference in their entirety.

### FIELD OF INVENTION

The present disclosure describes a system and method for separating solids from liquid-solid slurries.

### BACKGROUND

There are a number of applications that involve separating solids from liquid-solid slurries. These applications include, but are not limited to, sewage sludge dewatering, storm water catch basin cleaning, paper pulp processing, sediment removal, separating cuttings from extracted minerals in mining, and dredging. In many applications, an objective is to separate clean liquid from suspended solids as quickly as possible for the lowest cost. The cleanliness of the liquid may be measured by the percentage of suspended solids, which is a factor often determined by environmental rules or other criteria.

In some applications, the separated solids may be classified as solid waste, requiring disposal in a landfill. In landfill applications, the cost of disposal may be related to the weight and volume of the solids. Because liquids add significantly to both the weight and volume of the solids, there is a strong economic motive to minimize the moisture content of the separated solids. Energy consumption may also be a significant factor in the cost of separation.

In addition to various mechanical liquid-solid separation processes, many of these applications may also employ chemical liquid-solid separation technologies such as flocculants, coagulants, and charge packs. These chemical processes may operate in conjunction with mechanical liquid-solid separation, and chemicals may be inserted into the flow of the liquid-solid slurry either before or during the mechanical liquid-solid separation process. These chemical processes may work in various ways to make it easier for the mechanical separation processes to function. For example, the addition of polymer flocculants to a liquid-solid slurry assists the solids in joining together in clumps—known as “flocs”—which may be filtered or screened.

In some applications, such as hydraulic dredging, a party separating solids from a liquid-solid slurry faces a continuous flow of incoming slurry. For example, in commercial hydraulic dredging applications, this flow rate is generally a minimum of 500 U.S. gallons per minute, which is dictated by the flow rate of commercially available pumps. Other applications may require different flow rates for different periods of time.

Thus, there is a need for a highly effective system/method for separating solids from liquid-solid slurries which is capable of handling continuous flows at significant flow rates while enabling the removal of solids to meet appropriate moisture content requirements. In addition, there is a need to be able to supplement such a process with chemical liquid-solid separation technologies.

### SUMMARY

An objective of the present invention may be to employ mechanical processes for separating solids from a liquid-solid slurry to meet appropriate objectives for moisture content of the separated solids without requiring further chemical processing.

Another objective of the present invention may be to supplement mechanical processes for separating solids from a liquid-solid slurry with traditional chemical liquid-solid separation processes without limiting the effectiveness of the chemical process.

Another objective of the present invention may be to rapidly produce dried solids separated from a liquid-solid slurry and to expel the solids for disposal during separation process.

Yet another objective of the present invention may be to operate within a limited footprint. The present subject matter described herein may provide a solution to this problem by rapidly separating solids from a liquid-solid slurry thereby eliminating the need to store large volumes of liquid-solid slurry on site.

These and other objects may be achieved with a liquid-solid slurry separation method and system that may collect incoming liquid-solid slurry in a collection vessel. Excess liquid or slurry may be decanted from the vessel and transferred to a storage basin, released to the environment, separated in other types of mechanical separation systems, or separated in similar filter units as described herein.

Within the collection vessel, gravity and hydrostatic pressure may feed collected liquid-solid slurry into a pump. There may be a regulating mechanism which controls the flow of the slurry into the pump and which may be operated to slow or stop slurry flow between the collection vessel and the pump. The pump may also perform this regulating function. Other types of regulating mechanisms may include doors, gates, valves, including one-way valves to prevent the flow of slurry from the pump into the collection vessel. From the pump, slurry may flow into a filter element.

The filter element may include openings configured in a size and shape appropriate to capture the solids within the slurry while allowing liquids to escape. In some configurations, the filter element may be configured in a substantially horizontal or slightly inclined position and may be open at a far end. In other configurations, the end of the filter element may include a valve. Appropriate materials for manufacturing the filter element may include stainless steel, titanium, other non-reactive metals, polymers, ceramics, or other substances.

As the slurry passes into the filter element from the pump, the element captures the solids, and liquid passes through the openings in the filter. The force of the pump may compact the solids into a compressed “cake.” The pump may also push the solid cake through the opening at the end of the filter element.

When a piston pump is used, a regulator may be necessary to stop the flow of slurry from the collection vessel, though the piston itself may be the regulator. Piston pumps may employ multiple cylinders, each connected to a separate filter element, to enable continuous operation without a separate regulator. Other types of pumps may allow continuous operation without a separate regulator; these include but are not limited to screw pumps, progressive cavity pumps, and lobe pumps.

When a piston pump is used, depending on the volume of compressed cake within the filter element, the piston may be retracted, the regulating mechanism opened, and additional slurry may flow into the filter element, with the filtration and compaction process repeated until the filter element is substantially filled with solids in the form of a compressed cake.

When a piston pump is used, once an operator has reached a desired volume of solids at a desired moisture content, the piston or ram may then operate as a clearing mechanism to push the compressed solid cake through an opening at the end of the filter element for collection and disposal.

Some embodiments may have a valve at the end of the filter element. The valve may be closed to compact the collected solids and to remove additional moisture from the collected solids. When an operator wishes to expel the collected solids, the valve may be opened either before the expelling action or as a result of the force of expelling action.

With the filter element substantially cleared of collected solids, the pump may be operated to accept incoming slurry. In various embodiments with screw, progressive cavity, diaphragm, or other pumps that may be operated continuously, the continued operation of the pump is all that is necessary to accept incoming slurry. In alternative embodiments, such as those employing piston pumps, the piston may be retracted. Once the piston or ram has been retracted and the filter element is clear of any materials, the regulating mechanism may be opened to accept slurry or liquids from the collection vessel.

In embodiments with a valve at the end of the filter element, the valve may be closed with an actuator or automatically upon removing force applied to the valve or to a linkage or mechanism.

These and other features and advantages of the present disclosure will be understood upon review of the following detailed description, the accompanying drawings and the appended claims.

The present disclosure may address one or more of the problems and deficiencies of other attempted solutions discussed above. However, it is contemplated that the present disclosure may prove useful in addressing other problems and deficiencies in a number of technical areas. Therefore, the present disclosure should not necessarily be construed as limited to addressing any of the particular problems or deficiencies discussed herein.

In one aspect the invention features a system for separating solids from a liquid-solid slurry including a collection vessel having a first opening and at least one second opening positioned below the first opening. The collection vessel is configured to receive the liquid-solid slurry through the first opening and to discharge the liquid-solid slurry through the at least one second opening. There is at least one filter unit having a chamber with a first end, a second end and a filter surface between the first end and the second end of the chamber. The filter surface has a plurality of apertures and the second end of the chamber has a discharge port. There is at least one pump unit interconnected to the first end of the chamber of the at least one filter unit. One of the at least one filter unit or the at least one pump unit is in fluid communication with the at least one second opening in the collection vessel and is configured to receive the liquid-solid slurry from the at least one second opening and direct a flow of the liquid-solid slurry through the filter unit chamber. This causes liquid from the liquid-solid slurry to flow through the apertures and out of the chamber of the filter unit and causes solids from the liquid-solid slurry to be retained in the chamber of the filter unit. The at least one pump unit includes a discharge device which is translatable from the first end to the second end of the chamber of the filter unit to force solids retained in the chamber toward the discharge port.

In other aspects of the invention one or more of the following features may be included. The collection vessel may include a top portion, a bottom portion, a first end portion and a second end portion and wherein the first opening is in the top portion and the at least one second opening is in the bottom portion. The collection vessel may include a plurality of collection sections distributed from the first end portion to the second end portion and wherein the collection sections are separated by dividers. Each of the dividers may comprise a baffle. Each collection section of the collection vessel may include a second opening through which the liquid-solid slurry is discharged. There may be included a plurality of filter units and a like plurality of pump units one connected to each of the plurality of filter units, wherein one of each of the plurality of filter units or its pump unit is connected to one of the second openings in the collection sections. There may be a flow regulator in fluid communication with each of the second openings in the collection sections to regulate flow of the liquid-slurry discharged from each of the second openings. Each of the plurality of filter units may include a valve at the discharge port of the filter unit and wherein the valve may be selectively opened and closed to allow or disallow solids retained in the chamber to be discharged out of the discharge port. In a compression mode, for each of the plurality of filter units the valve at the discharge port of the filter unit may be closed and the discharge device is activated to translate toward the second end of the chamber to compress the solids in the chamber against the closed valve and force out retained liquid from the solids. Each of the valves may include a door which is pivotably mounted to the chamber at the discharge port so that when the solids retained in the chamber are forced against the door by the discharge device as it is translates from the first end to the second end of the chamber the door is opened; and wherein each door may include a spring affixed to the door and to the filter unit proximate the discharge port which expands when the door is opened as the discharge device forces solids out of the discharge port and when the solids are discharged and when the discharge device retracts the spring retracts and causes the door to close.

In yet other aspects of the invention one or more of the following features may be included. Each pump may include a pump inlet connected to the second opening to receive the flow of the liquid-solid slurry from a respective collection section. Each pump may include a pump cavity interconnected to the pump inlet, and wherein the pump cavity may be interconnected to the filter chamber so as to allow the flow of liquid-solid slurry to pass through the pump cavity and into the filter chamber. The discharge device may include a piston and an actuator to extend and retract the piston; wherein when the piston is in a retracted position it is located in the pump cavity and when it is activated to extend it translates through the pump cavity and into the filter chamber to cause a surface of the piston to force solids retained in the chamber out of the discharge port. When the piston is activated to extend from the pump cavity to the filter chamber, the piston may block the pump inlet thereby preventing the flow of the liquid-slurry discharge until after the piston is retracted and is no longer blocking the pump inlet. Each filter unit may have a quadrilateral cross-section. The apertures in each filter unit may be disposed in each of four sides of the chamber and the apertures each have a length substantially greater than its width. The at least one filter unit may include a liquid collection vessel to collect the liquid from the liquid-solid slurry which flows through the apertures; and there is further included a conduit in communication with the liquid collection vessel and configured to direct liquid from the liquid collection to the first opening in the collection vessel for further filtration.

In another aspect the invention features a method for separating solids from a liquid-solid slurry including introducing a liquid-solid slurry into a collection vessel through a first opening and discharging the liquid-solid slurry through at least one second opening positioned below the first opening. The method includes providing at least one filter unit having a chamber with a first end, a second end, and a filter surface between the first end and the second end of the chamber, the filter surface having a plurality of apertures, the second end of the chamber having a discharge port. The method also includes providing at least one pump unit interconnected to the first end of the chamber of the at least one filter unit. The method additionally includes receiving the liquid-solid slurry from the at least one second opening by the at least one filter unit or the at least one pump unit and directing a flow of the liquid-solid slurry through the filter unit chamber to cause liquid from the liquid-solid slurry to flow through the apertures and out of the chamber of the filter unit and to cause solids from the liquid-solid slurry to be retained in the chamber of the filter unit. The method further includes forcing solids retained in the chamber toward the discharge port using a discharge device which is part of the at least one pump unit, wherein the discharge device is translatable from the first end to the second end of the chamber of the filter unit.

In other aspects of the invention one or more of the following features may be included. The collection vessel may include a top portion, a bottom portion, a first end portion and a second end portion and wherein the first opening is in the top portion and the at least one second opening is in the bottom portion. The method may include providing the collection vessel includes providing a plurality of collection sections distributed from the first end portion to the second end portion and wherein the collection sections are separated by dividers. Providing the plurality of collection sections may include providing each of the dividers with a baffle. Providing the plurality of collection sections may include providing each collection section with a second opening through which the liquid-solid slurry is discharged. The method may include providing a plurality of filter units and a like plurality of pump units one connected to each of the plurality of filter units, wherein one of each of the plurality of filter units or its pump unit is connected to one of the second openings in the collection sections. The method may include regulating a flow of the liquid-slurry discharged from each of the second openings using a regulator in fluid communication with each of the second openings in the collection sections. The method may include providing each of the plurality of filter units with a valve at the discharge port of the filter unit and selectively opening and closing the valve to allow or disallow solids retained in the chamber to be discharged out of the discharge port.

In yet other aspects of the invention one or more of the following features may be included. The method may include closing, in a compression mode, the valve at the discharge port of each of the filter units and translating the discharge device toward the second end of the chamber to compress the solids in the chamber against the closed valve and force out retained liquid from the solids. The method may include providing each of the valves with a door pivotably mounted to the chamber at the discharge port, translating the discharge device from the first end to the second end of the chamber to force the solids retained in the chamber against the door, causing the door to open and a spring affixed to the door and to the filter unit proximate the discharge port to expand and when the discharge device forces solids out of the discharge port retracting the discharge device causing the spring to retract and close the door. The method may include providing each pump with a pump inlet connected to the second opening to receive the flow of the liquid-solid slurry from a respective collection section. The method may include providing each pump with a pump cavity interconnected to the pump inlet, and connecting the pump cavity to the filter chamber so as to allow the flow of liquid-solid slurry to pass through the pump cavity and into the filter chamber. The method may include providing the discharge device with a piston and an actuator to extend and retract the piston; wherein when the piston is in a retracted position it is located in the pump cavity and when it is activated to extend it translates through the pump cavity and into the filter chamber to cause a surface of the piston to force solids retained in the chamber out of the discharge port. The method may include extending the piston from the pump cavity to the filter chamber, and causing the piston to block the pump inlet thereby preventing the flow of the liquid-slurry discharge until after the piston is retracted and is no longer blocking the pump inlet. The chamber of each filter unit may have a quadrilateral cross-section. The method may include disposing the apertures in each filter unit in each of four sides of the chamber and providing the apertures with a length substantially greater than its width. Providing the at least one filter unit may include providing a liquid collection vessel to collect the liquid from the liquid-solid slurry which flows through the apertures; and further providing a conduit in communication with the liquid collection vessel to direct liquid from the liquid collection to the first opening in the collection vessel for further filtration.

### BRIEF DESCRIPTION OF THE FIGURES

FIG. 1 is a block diagram of a system for separating solids from a liquid-solid slurry.

FIG. 2A is a perspective view of a system for separating solids from a liquid-solid slurry according to an aspect of this invention.

FIG. 2B is schematic diagram of a controller for controlling the system for separating solids from a liquid-solid slurry of FIG. 2A.

FIG. 2C is a side elevation view of a system for separating solids from a liquid-solid slurry according to an aspect of this invention.

FIG. 3A is perspective view of a pump and filter element for separating solids from a liquid-solid slurry.

FIG. 3B is perspective view of a valve on a filter element for separating solids from a liquid-solid slurry.

FIG. 4 is a sectional view of a piston pump in retracted position and a filter element for separating solids from a liquid-solid slurry.

FIG. 5 is a sectional view of a piston pump in operation and a filter element for separating solids from a liquid-solid slurry.

FIG. 6 is a flow diagram of a method for separating solids from a liquid-solid slurry.

### DETAILED DESCRIPTION

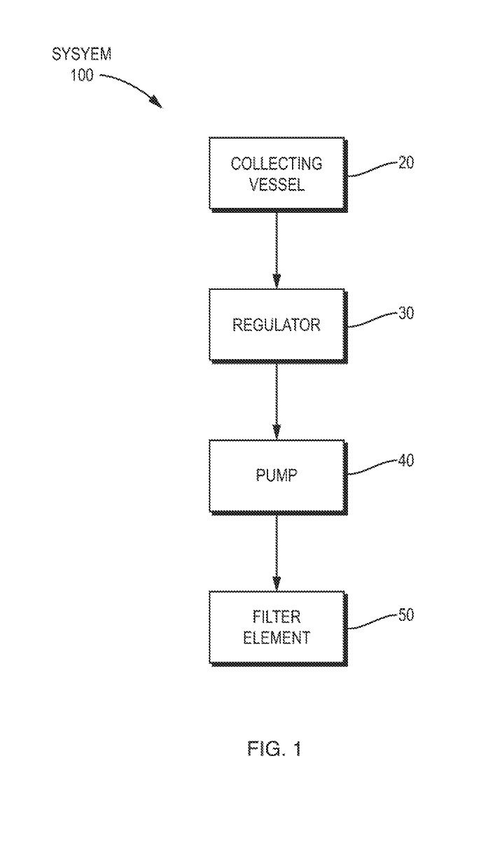

FIG. 1 illustrates a system 10 for separating solids from a liquid-solid slurry. The system 10 may include a collection vessel 20, a regulator 30, a pump 40, and a filter element 50. Such a system is described below with reference to FIG. 1 as well as the additional figures. The primary aspects of the system, namely, material handling, system overview, the collection vessel, the filter element, the pump, and system operation are described in turn below.

### 1) Material Handling

### a) Pre-Treating Incoming Slurry

In various embodiments, the liquid-solid slurry may be treated with a combination, mixture, or compound of liquid-solid separation chemicals assembled into a separation chemistry. The presence of separation chemistry may assist in the operation of the system 10 for separating solids from a liquid-solid slurry as discussed herein, though the separation chemicals are not required at all stages of operation, and separation chemistry may be added to the slurry at various points in the operation of the system 10 for separating solids from a liquid-solid slurry as discussed herein. For example, in some embodiments, separation chemistry may be present in the slurry introduced into the collection vessel 20, and in other embodiments, the separation chemistry may be added to the slurry after the slurry has entered the collection vessel 20.

In various other embodiments, the liquid-solid slurry may pass through a shaker screen, a rock box, a sand screw, or similar structure to remove objects of specific sizes before the slurry enters the collection vessel 20.

### b) Liquid

Various embodiments of system 10 separate a liquid-solid slurry into liquid and solid components. The collected solids may be disposed of in the environment, in a landfill, or in another process. The liquids, which in various embodiments include water, may be drained, decanted, or collected and returned to the environment, stored, cleaned, filtered, or employed in another process. In some embodiments, decanted or filtered liquid may be reintroduced into the incoming slurry to recycle the separation chemistry, to optimize the liquid-solid ratios, or to otherwise facilitate the solid separation process. In some further embodiments, the decanted or filtered liquid may be introduced into the slurry flow before the slurry enters the system 10 for separating solids from a liquid-solid slurry as shown in FIG. 1.

### c) Solids

In various embodiments, solids separated from a liquid-solid slurry are compressed into “cake” form, which represents separated solids at a desired moisture content. In some embodiments, the appropriate moisture content of the solid cake may be measured with a “paint filter test,” in which solid cake is placed in a paint filter for a period of time—if water breaks away from the solids, then it indicates that the cake contains too much moisture and requires additional filtering or drying. Separated solids may be extracted from the filter element 50 and returned to the environment, stored, disposed of in a landfill, composted, or used in other processes.

### 2) System Overview

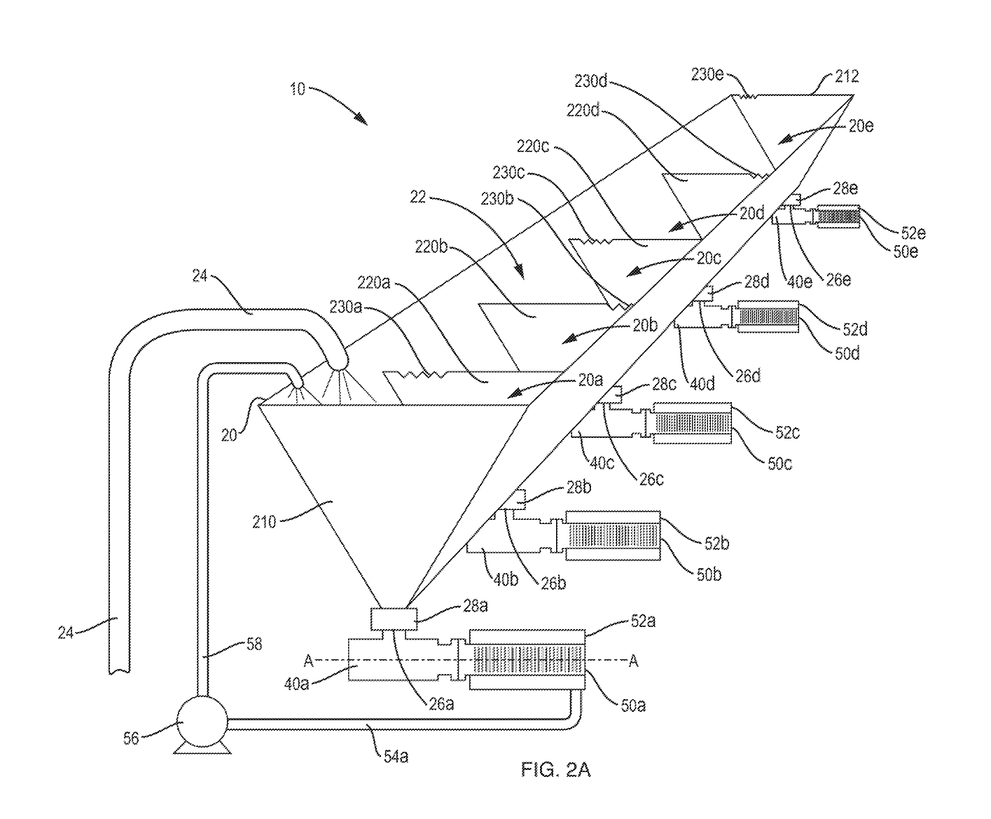

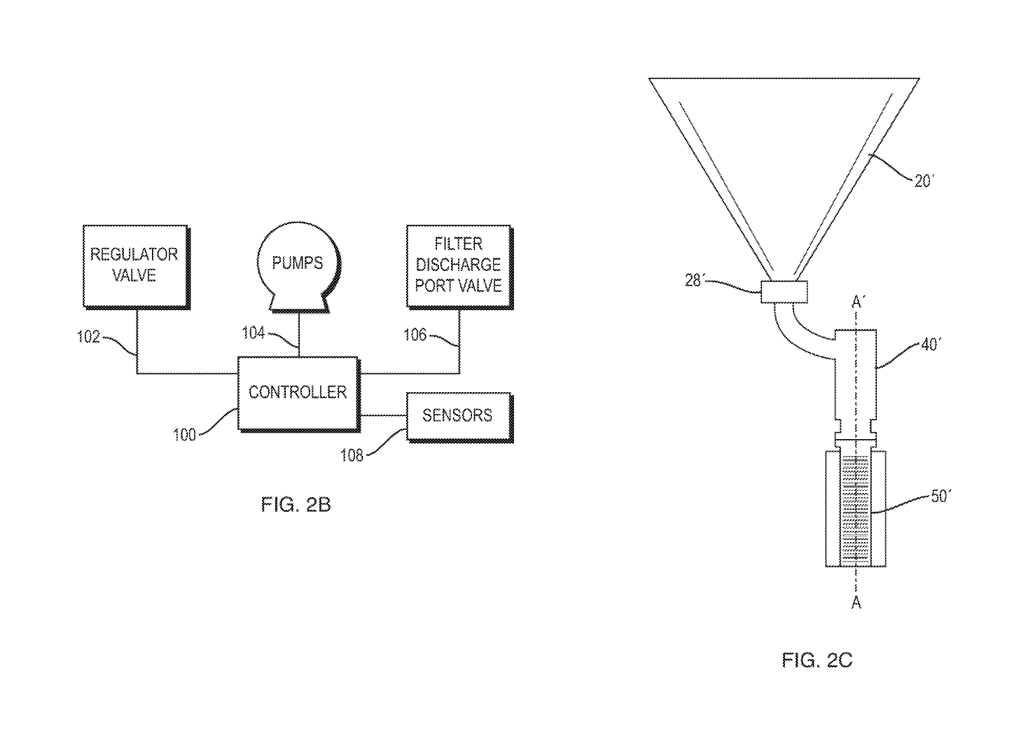

An overview of the main components of system 10 for separating solids from a liquid-solid slurry is depicted in FIG. 2A to include a collection vessel 20 having a first opening 22 located at the top of the collection vessel 20. Collection vessel 20 is configured to receive the liquid-solid slurry from a spillway 24 from a source (not shown) and to deliver the liquid-solid slurry into the first opening 22.

Collection vessel 20 includes a first end portion 210 and a second end portion 212 between which are included a plurality of collection sections 20a-20e distributed from the first end portion 210 to the second end portion 212. The collection sections are separated by dividers 220a-220d which are lower in height than the top opening 22 of the collection vessel 20. Each divider includes a baffle 230a-230e which allows liquid solid slurry to flow over from one collection section to the next by passing through the respective baffle. The filtered liquid in the end collection section 20e when filled to the level of baffle 230e drains out from the collection vessel into a container (not shown).

At the bottom of collection vessel 20 there are openings 24a-24e in each collection section 20a-20e, respectively, through which the liquid-solid slurry may be discharged and provided to a pump/filter unit. The pump units 40a-40e are shown to receive the liquid-solid slurry from the collection vessel, however, the flow from the collection vessel could alternatively be received by the filter units 50a-50e which are interconnected to the pump units 40a-40e, respectively. To regulate flow from the collection section to a pump/filter unit a regulator, such as regulator 28a interconnected to collection section 20a, may be included. The regulator may be any kind of suitable valve which can be manually or automatically operated. In the case of automatic operation, the valve may be opened and closed via hydraulic, pneumatic, or electrical actuation under the control of a control system. Such a regulator may be interconnected between each of the other collection sections 20b-20e and their respective pump/filter units, but for clarity they are not shown in this figure. As described below, instead of providing a separate regulator, the pump units 40a-40e may be configured to operate as a flow regulator.

Each one of the filter units 50a-50e has a chamber with a first end connected to a pump unit and a second end with a discharge port through which filtered solids may be discharged after they have been collected. At the discharge port there may be included a valve or gate (not shown in this view) which may be operated manually or controlled to open and close automatically under the control of a control system. The filter units each have a filter surface with a plurality of apertures, through which liquid from the liquid-solid slurry flows leaving solids in the filter chamber. Each pump unit 40a-40e may be used to force solids retained in its respective filter chamber towards and out of the discharge port. This may be done by manually activating the pump or automatically using a control system. This process is described in more detail below.

The liquid exiting the filter units may then be collected in a collection tank (not shown) if the output (or effluent) for a particular application is sufficiently clean. The effluent would then be removed from the site and properly disposed. However, in certain applications, the effluent may need to be recirculated for further filtering before it may be collected and disposed. In this case, the liquid from the liquid-solid slurry which has flowed through the filter surfaces in the filter chambers may be collected by a liquid collector surrounding the filter unit.

For ease of description, only liquid collector 52a is shown, however, it will be understood that a liquid collector associated with each filter unit 50a-50e may be included. Liquid collector 52a is interconnected to a conduit 54 to receive the effluent which is then pumped by pump 56 up conduit 58 where the effluent is reintroduced into collection section 20a for further filtration. It should be noted that effluent from each other filter unit 50b-50e could be recirculated to its respective collection section or the filter units may be interconnected to a manifold connected to pump 56 for recirculation to collection section 20a.

As shown in FIG. 2B, a controller 100 for controlling the operation of system 10 may include signal line 102 connected to the regulator valves 28 to stop the flow of liquid-solid slurry from the collection sections, for example to allow the filter units to be cleared of solid material collected therein. Once the regulator is closed, controller 100, through signal line 104 connected to actuators for pumps 40 and signal line 106 connected to the filter unit discharge ports, may control the pumps and discharge port valves. The pumps may be activated to compress the solid material against the discharge port valve when it is closed (under the control of controller 100) to remove liquid from the solid material as it is compressed against the valve and then to force the solid material out of the discharge port when the controller 100 opens the discharge port valves.

An alternative arrangement of the pump/filter units relative to the collection vessel is depicted in FIG. 2C. Here the pump unit 40′ interconnected to filter unit 50′ is shown to be oriented with its longitudinal axis A′ vertically disposed relative to the collection vessel 20′, as opposed to pump/filter units 40/50 of FIG. 2A where the longitudinal axes A are oriented horizontally relative to the collection vessel 20. It should be noted that the angle of orientation of the pump/filter units may be chosen based on the particular liquid-solid slurry being filtered and may be set at any suitable angle between horizontally and vertically oriented the embodiments shown. Orienting the pump/filter units between horizontal and vertical may allow the build-up of solids in the filter to disperse along the length of the filter chamber rather than to collect at one end or the other.

### 3) Collection Vessel

In some embodiments, the collection vessel 20 of FIG. 2A may be conical in shape (as shown), and in other embodiments, the sides may be substantially planar and assembled to form a rectangular vessel. In other embodiments, more than one collection vessel may be joined together to operate in concert so that slurry flows from a first collection vessel to a second collection vessel.

In some embodiments, the divider 220 shared by adjacent collection sections of collection vessel 20 may comprise a single sheet of material, or it may comprise several elements to provide appropriate geometry for routing the slurry into one or more pumps 40 as necessary. In some embodiments, liquid-solid slurry may flow between collection sections 20a-20e via baffles 230 located at the top of a dividers 220. The baffles 230 shown in FIG. 2 are constructed in a saw tooth configuration. Other embodiments may include baffles 230 with grates, fences, or other objects to catch debris, such as organic matter and foreign objects that may otherwise pass between filter units. Yet other embodiments may include an opening, such as a sluice, instead of a baffle.

In some embodiments, the dividers 220 between individual collection sections may be lower than the exterior sides of the collection vessel 20 assembled into a system. The lower dividers 220 may allow slurry to pass between collection sections when the flow of slurry between the collection sections exceeds the capacity of the given collection section. In some embodiments, the collections sections may be separated only by dividers 220 without baffles 230. In various embodiments, slurry may pass from a first collection section to a second collection section when flow to a filter element 50 in the first collection section is stopped, such as when an operator has closed a regulator 30 or has stopped operation of a pump 40 and may be clearing solids from a filter element 50.

In some embodiments, the collection vessel 20 may resemble and operate as a manifold, and this manifold may be either open to the environment or enclosed in some manner. In some alternative embodiments, there may be no dividers. In other embodiments, more than one pump 40 may be connected to the collection vessel 20 or to each collection section, or a single collection vessel 20 may ultimately feed through pumps 40 and into more than one filter element 50.

In some embodiments, optimal operation of the filter system 10 may involve decanting as much liquid as possible from the collection vessel while enabling slurry to flow into the pump 40. In some embodiments liquid may pass over either the baffles 230 or divider 220. Some embodiments may not include a baffle 230, and in these embodiments liquid may pass over the divider 220. This may be a part of normal operation as clean liquid decants from one collection section to the next in the system 10 for separating solids from a liquid-solid slurry. In order to facilitate this flow, a second collection section may be placed lower than a first collection section; however, other configurations of dividers 220, baffles 230, and collection sections may be possible. Decanted liquid may be returned to the environment or collected as with the liquid separated elsewhere from the liquid-solid slurry as described herein.

### 3) Filter Element

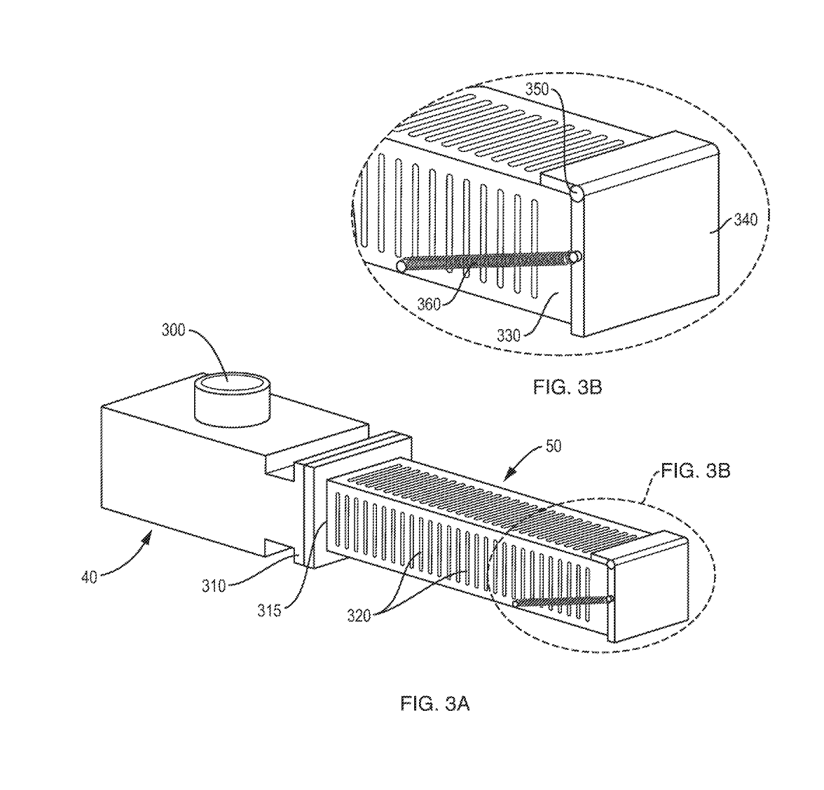

FIGS. 3A and 3B provide greater detail of the filter element 50 and associated structures. Slurry may pass through a pump inlet 300 that connects the pump 40 to the collection vessel 20. In some embodiments, more than one pump 40 may be connected to a single collection vessel 20. Correspondingly, in some further embodiments, more than one filter element 50 may be connected to a single collection vessel 20 through one or more pumps 40.

### a) Structure

The filter element may include a plurality of filter openings or apertures 320 that may be of various sizes and shapes to address different types of solids within the slurry. For example, the filter opening 320 for filtering a fine, silt material may be smaller than a filter opening 320 intended to filter sand from a liquid-solid slurry. The embodiment of filter opening 320 depicted in FIGS. 3A and 3B is shown to be linear, but those skilled in the art will recognize that other shapes of opening are possible in other embodiments. Also, the filter element 50 in FIGS. 3A and 3B shows an embodiment with a quadrilateral cross section, though other embodiments may have other types of cross sections that may be circular, elliptical, triangular, or other shapes. The filter openings 320 may be placed in various locations on the filter element. The openings 320 as depicted in FIGS. 3A and 3B show a uniform distribution of openings of a uniform size; however, in other embodiments, openings on one or more sides of the filter element may be omitted. In yet other embodiments, the concentration or density of filter openings 320 may vary from one location on the filter element 50 to other locations on the filter element 50. In further embodiments, the size, shape, and concentration of filter openings 320 may vary depending on the materials in the slurry and the location of the filter openings 320 on the filter element 50.

In some embodiments, the filter element 50 as shown may be constructed out of metal. While many metals may suffice, those skilled in the art will recognize that non-reactive metals, such as stainless steel, may be preferable in some applications. The filter element 50 may be formed out of sheet metal by rolling or bending and brazing, welding, bonding, or other manufacturing methods known to those skilled in the art. In sheet-metal construction, the filter openings 320 may be cut out of the sheet before forming. Cutting methods may involve blades, etching, water jets, lasers, plasma, and other types of manufacturing approaches known to those skilled in the art.

In other embodiments, the filter element 50 may be extruded, cast, forged, or manufactured in an appropriate manner as known to those skilled in the art. In yet other embodiments, the filter element 50 may be constructed out of nonmetallic materials such as polymers, ceramics, and composite materials. In various embodiments, the filter openings 320 may be cut from the formed filter element, formed as part of element construction, or cut from the filter element material before the filter element is formed. In some embodiments, the filter openings 320 may be cut, etched or formed during molding, casting or forging.

Filter element 50 may be connected to a pump 40 with a bolted flange. In other embodiments, the pump 40 and filter element 50 may be attached using a variety of fasteners and connecting methods. In yet other embodiments, the filter element 50 may be formed in a single, integral unit with the pump 40. Those skilled in the art will recognize the advantages of a replaceable filter element 50 that may be changed to accommodate slurry types and to address wear in the filter element 50.

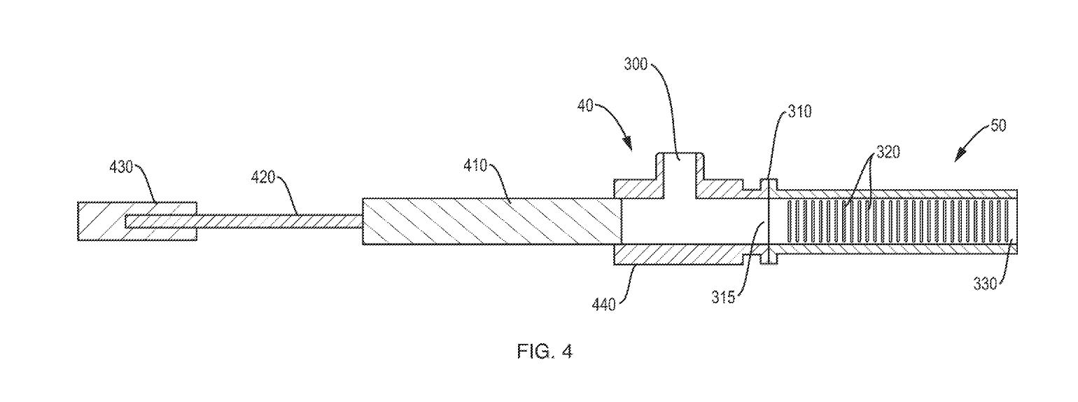

In various embodiments, such as those including a piston-type pump 40 or any other pump 40 in which a pump inlet 300 as shown in FIG. 4 may be directly connected to a pump outlet 315, the hydrostatic pressure of the slurry in the collection vessel 20 may push solids through the pump 40 and into the filter element 50. In such an embodiment, this force may compact the solids against the filter element 50 and may cause solids to build up within the filter element 50. In other embodiments, the pump 40 may push solids into the filter element 50 and compact those solids that build up within the filter element 50. It may be desirable for the pump 40 to apply sufficient force to compact the solids to a desired moisture content and to also expel the solids from the end 330 as shown in FIG. 3A. In further embodiments with a valve 340 at the end 330 of the filter element 50 the force applied by the pump 40 may need to also be sufficient to actuate or open the valve 340, if the valve 340 operates by force applied by the solid cake in the filter element 50.

### b) Performance

In addition to the size and shape of the filter openings 320, various other factors may contribute to the performance of the filter element, including but not limited to: cross-sectional area of the filter element 50, height of the collection vessel 20, length of the filter element 50, and the presence or absence of a valve 340 at the end of the filter element 50.

In various embodiments, reducing the cross-sectional area of the filter element 50 may increase the force applied by the hydrostatic pressure of the slurry in the collection vessel. This may assist in compacting the solids collected in the filter element 50. Alternatively, increasing the height of the collection vessel 20 may achieve a similar result, although as the height of the collection vessel 20 increases, the vessel may begin to operate as a clarifier, and solids may separate from the slurry in the collection vessel 20.

In various embodiments, an objective may be to prevent solids from separating from the slurry in the collection vessel, because the solid materials may form “dams” within the collection vessel, which presents several problems well known to those skilled in the art. First, the collected solids within the vessel must be removed from the collection vessel, often manually. Second, the presence of “dams” leads to “rat-holing” within the collection vessel, which make it difficult for an operator to manage slurry flow. Third, in order to clear the collection vessel 20, one may need to introduce additional liquids into the vessel, often with additional separation chemistry as well. While it is possible to decant liquids from a slurry above the line between liquid and slurry—often referred to as the “water break”—an objective of the system 10 for separating solids from a liquid-solid slurry as discussed herein may be to primarily separate the solids from the slurry, below the water break, within the filter element 50. Those skilled in the art will recognize that many embodiments may tolerate some degree of solid separation within the collection vessel 20 so long as the solid separation does not affect slurry flow into the pump 40 and filter element 50.

In various embodiments, another factor in the performance of the filter element 50 may be the length of that structure. In some embodiments, a longer filter may not include a valve 340, such as the door valve as shown in FIGS. 3A and 3B. In some embodiments, such as filter elements four inches square in cross section and fifteen feet long, solids may build up in a region within the filter element 50. In some embodiments, solids may aggregate within the filter element 50 to the point where the solids fill the entire cross section of the filter element 50, and subsequent additional solids may accumulate between the pump inlet 300 and the aggregation of separated solids within the filter element 50. Inclining the far end of the filter element 50 relative to the pump inlet 300 may facilitate the accumulation of separated solids.

In alternative embodiments, an operator may require a shorter filter element 50 in order to satisfy the constraints of space for transport. For example, in a system 10, FIG. 2A, for separating solids from a liquid-solid slurry that may be designed for transport on a standard commercial trailer, an operator may choose a filter element that is eight feet long. In some embodiments, a filter door valve 340 as shown in FIG. 3B may facilitate accumulation of separated solids. In some embodiments, the valve 340 may open with a hinge 350 and may be held closed by a spring 360. The spring 360 may be of an appropriate spring constant so as to keep the valve closed while solids accumulate and to allow the valve to open during the extraction cycle discussed herein.

### c) Filter Valve

FIGS. 3A and 3B shows an embodiment of a filter element 50 with a filter end 330 covered by a valve 340 that may regulate the flow of collected solids from the filter element 50. Those skilled in the art will recognize that numerous alternative embodiments of the valve 340, hinge 350, and spring 360 may be possible. For example, in one embodiment a valve 340 and hinge 350 combination may operate with a linkage and actuator instead of the spring 360 to hold the door valve 340 closed during solid accumulation and then to open the door valve during the extraction cycle. In another embodiment, the spring 360 may be absent, and the valve 340 may be held closed with screws or bolts and operated manually.

In yet another embodiment, the valve 340 may be a gate, butterfly, or ball valve, and the hinge 350 and spring 360 may be absent, and an electric motor, solenoid, hydraulic actuator, pneumatic actuator, or other device may operate the valve 340. In a further embodiment, the valve 340 may be a duckbill valve, and the hinge 350 and spring 360 may be absent. In a yet further embodiment, the valve 340 may include a bladder and the hinge 350 and spring 360 may be absent—the bladder may be filled with a gas or liquid to prevent solids from escaping from the end of the filter element 50. In various embodiments, electrical, magnetic, electromagnetic, hydraulic, pneumatic, or other actuators may replace the spring 360 in numerous possible configurations to achieve a similar result.

The operation of the embodiment of filter unit 50 shown in FIGS. 2-4 is described. Each of the plurality of filter units 50 may include includes a valve 340 at the discharge port 330 of the filter unit and the valve may be selectively opened and closed to allow or disallow solids retained in the chamber to be discharged out of the discharge port. Moreover, in a compression mode, initiated manually by an operator or automatically by controller 100, FIG. 2B, for each of the plurality of filter units 50 the valve 340 at the discharge port 330 of the filter unit is closed and the discharge device (pump 40) is activated to translate toward the second end of the filter chamber to compress the solids in the chamber against the closed valve 340 and causing the solids to compress and force out retained liquid from the solids.

Valve 340 includes a door which is pivotably mounted to the chamber of the filter unit by a hinge 350 at the discharge port so that when the solids retained in the chamber are forced against the door by the discharge device (pump 40) as it is translates from the first end to the second end of the chamber the door is opened. The door includes a spring 360 affixed to the door and to the filter unit proximate the discharge port which expands when the door is opened as the discharge device forces solids out of the discharge port and when the solids are discharged and the discharge device retracts the spring retracts and causes the door to close.

### 4) Pump

In order to compress and expel collected solids, as described above, the system 10 may include a pump 40 as shown in FIGS. 2 and 3A. Pump 40 capable of handling a slurry, including but not limited to the following pump types: centrifugal, diaphragm, lobe, piston, progressive cavity, rotary, and screw.

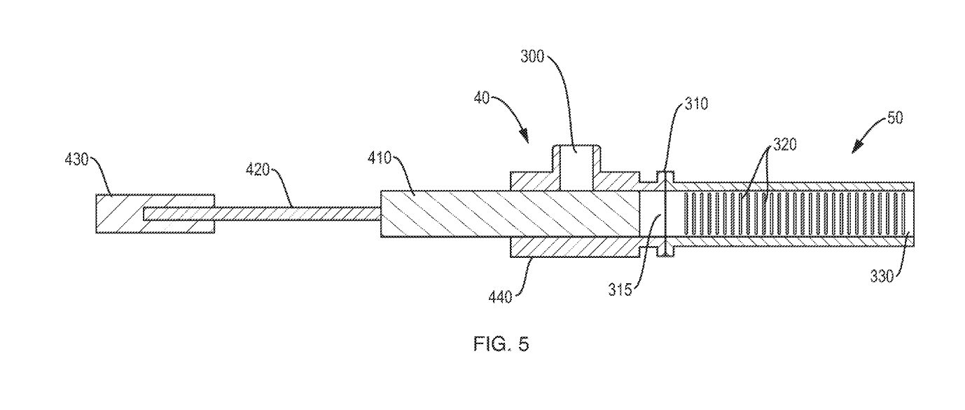

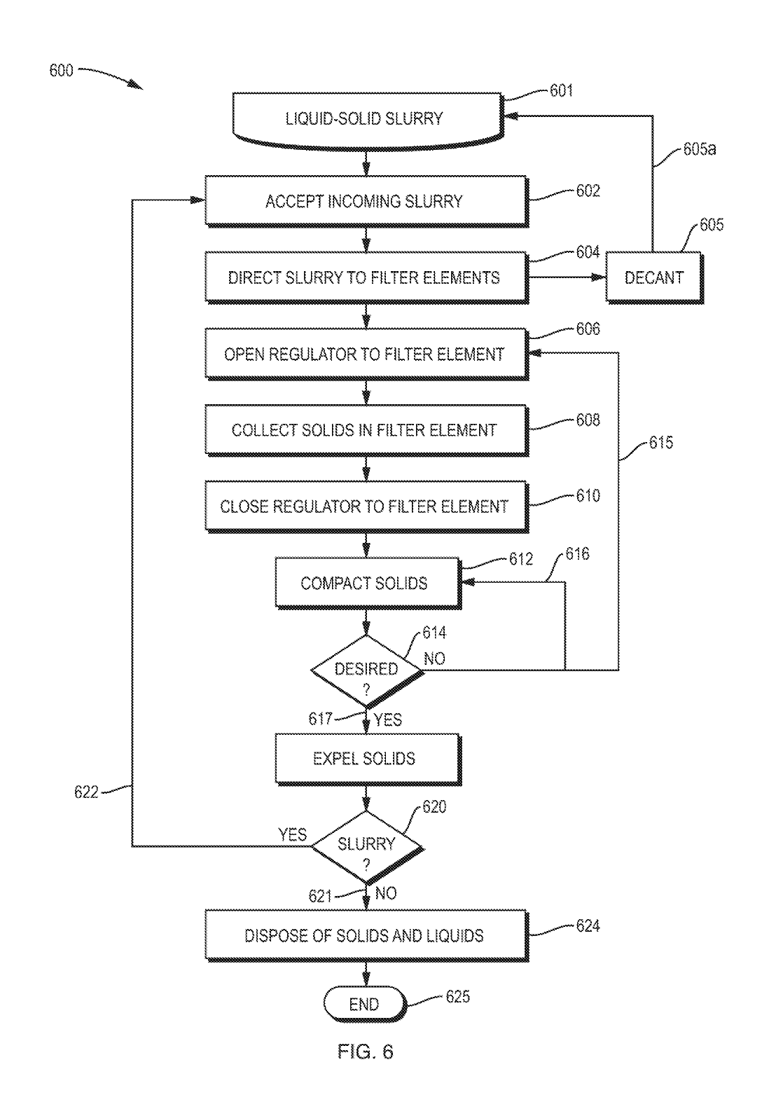

The embodiment shown in FIGS. 4 and 5 includes a piston pump 40, which includes a piston 410, a connecting rod 420, and an actuator 430. As discussed below, in comparison to embodiments with other types of pump 40, embodiments with a piston pump 40 may require additional structures, such as a regulator 30, or additional operating steps as shown in FIG. 6 and discussed below.

A purpose of the pump may be to compact the collected solids within the filter element 50 and to expel the collected solids from the filter element 50 when an operator desires or under the control of the controller, FIG. 2B. In some embodiments, more than one pump 40 may be used. For example, a first pump 40 may be used to compact collected solids, and a second pump 40 may be used to expel collected solids. In other embodiments, a first pump 40 may be of a different type and may operate in a different manner than a second pump 40.

### a) Filter Openings

Those skilled in the art will recognize that many types of pumps may not function with filter openings 320 as shown in FIGS. 3-4 in the pump housing 440. For example, in the case of a screw pump, if the filter openings 320 are present in the pump housing 440 and solid cake forms within the screw pump, the solid cake may remain in the screw pump and may not discharge. Similarly, in a progressive cavity pump, the presence of filter openings 320 in a stator of said pump would most likely render the pump inoperative. However, other types of pumps, such as piston pumps, may tolerate the presence of filter openings 320 in the pump cylinder and the pump housing 440.

b) Regulating Flow into the Pump

One may regulate flow through the pump inlet 300 in a number of ways, including but not limited to doors, gates, and valves. For example, in some embodiments, the regulator 30 may be a door located within the collection vessel 20, or affixed to it as shown in FIG. 2A, that prevents flow into the pump inlet 300. In other embodiments, the regulator 30 may be the pump 40 or may be an internal component of the pump 40. In yet other embodiments, the regulator 30 may be a mode of operation of the pump 40 so that an operator may achieve a desired outcome. In various embodiments, the type of pump 40 used in the filter system 10 may determine whether or not an operator may use a regulator 30 to control the flow of slurry into the pump inlet 300 as shown in FIG. 3A.

There are several types of embodiments of pump 40 and regulator 30 combinations. In a first embodiment of regulator 30 and pump 40 combination, slurry may flow when the pump 40 is operated, and no separate regulator 30 is necessary. In this embodiment, the pump 40 may perform the function of the regulator 30, and whatever flow control capability exists in the pump 40 may define the regulating ability of the system 10. Examples of this first embodiment include, but are not limited to, progressive cavity pumps, lobe pumps, and screw pumps—when these types of pumps are not operating, slurry may not flow from the pump inlet 300 to the pump outlet 315 as is possible with the piston pump 40 shown in FIGS. 4 and 5.

In a second embodiment of regulator 30 and pump 40 combination, a separate regulator 30 may be necessary to prevent the system 10 from operating in an undesired manner. For example, as is shown in FIG. 4, slurry may flow directly from the pump inlet 300, through the pump outlet 315, and into the filter element 50, and an operator may wish to prevent this flow. Some embodiments may include a separate regulator 30, though other pump 40 embodiments may include a regulator 30 internal to the pump 40.

In another scenario where undesired pump 40 operation may require a regulator 30, FIGS. 4 and 5 show a piston pump 40 where operation of the piston 410 past the pump inlet 300 may disable the pump 40 if slurry were to flow behind the piston 410. In this embodiment, a regulator 30 may prevent this slurry flow; however, a regulator 30 may not be necessary, because as shown in FIG. 5, which is not to scale, a piston 410 of sufficient length may serve the regulating function by blocking slurry flow through the pump inlet 300 while also allowing pump operation to compact collected solids within the filter element 50 and to expel collected solids through the filter end 330.

In other embodiments, such as those with an auger pump 40, a regulator 30 may be the only way to stop slurry flow, because slurry may flow past the auger, thereby connecting the pump inlet 300 with the pump outlet 315, and no operation of the auger pump 40 will prevent this flow. Otherwise, those skilled in the art will recognize that in various embodiments, a number of structures and approaches may address the regulating function, including: an external regulator 30, a regulator 30 contained within the pump 40, an alternate design of the pump 40, or operation rules for the pump 40.

In a third embodiment of regulator 30 and pump 40 combination, a regulator 30 may be necessary to prevent slurry from flowing from the pump 40, through the pump inlet 300, and into the collection vessel 20. For example, in embodiments employing a diaphragm pump, a regulator 30 may prevent slurry from flowing back through the pump inlet 300 and into the collection vessel 20. In various embodiments, the regulator 30 may include a one-way valve, such as a check valve. As described above, the regulator 30 may be internal to the pump 40 or contained within the pump housing 440. Other pump types may require similar regulation.

The pump 40 includes a pump cavity interconnected to the pump inlet 300 and to the filter chamber at pump outlet 315 so as to allow the flow of liquid-solid slurry to pass through the pump cavity and into the filter chamber. The piston 410 is driven by actuator 430 to extend and retract the piston; 410. When the piston is in a retracted position it is located in the pump cavity and when it is activated to extend it translates through the pump cavity and into the filter chamber to cause a surface of the piston to force solids retained in the chamber out of the discharge port

### c) Multiple Pumps

Those skilled in the art will recognize that numerous types of commercially available slurry pumps 40 operate in duplex, triplex, and other configurations with two, three, or more pump assemblies operating in concert to allow continuous operation and steady slurry flow. For example, piston pumps and diaphragm pumps are commonly assembled in these configurations, because these types of pumps may not accept slurry during the cycle time in which a piston 410 is either pumping or retracting or a diaphragm is pumping slurry into the filter element 50. Various embodiments may include multiple pump 40 assemblies that share a common pump inlet 300 manifold connected to a single collection vessel 20. In other embodiments, each pump 40 within a multiple pump assembly may have a pump inlet 300 collected to a collection vessel 20. In some embodiments with a multiple pump 40 assembly, each pump 40 may be connected to a filter element 50. In other multiple pump 40 embodiments, multiple pumps 40 may be connected to one or more filter elements 50.

### d) Piston Pump

As discussed above, operating a piston pump for these aforementioned purposes may requires an operator to stop flow to the filter element 50 when the piston pump is in operation. This may be accomplished with a regulator 30 that may be a distinct structural element such as a door, gate, or valve; however, in the embodiment as shown in FIGS. 4 and 5, which are not to scale, the piston 410 may regulate the flow of slurry by stopping slurry flow when the piston 410 is actuated and throughout the range of motion for piston 410.

In FIG. 5, piston 410 has been actuated to either compact, expel, or both compact and expel the solids collected in the filter element 50, and slurry may not flow through the pump inlet 300. The embodiment of the piston 410 as shown in FIG. 5 is not to scale, and those skilled in the art will recognize that the operation of the piston 410 to regulate slurry flow through the pump inlet 300 may require a piston that is roughly as long as the distance between the pump inlet 300 and the end of the filter element 50. Various other embodiments of the piston 410 may include telescoping elements or sliding collars to block the flow of slurry through the pump inlet 300 while the piston is in operation.

Referring again to FIG. 5, the piston 410 has been actuated by an actuator 430, which is connected to the piston 410 through a connecting rod 420. Various embodiments may employ hydraulic, pneumatic, electrical, rotary, or other form of actuation 430 known to those skilled in the art. In various embodiments, the connecting rod 420 may employ a mechanical linkage and operate through linear displacement or a combination of axial rotation and linear displacement. In multiplex pumping assemblies, the actuator 430 may be a common crankshaft or a camshaft and linkage.

In various embodiments employing a piston pump 40, the piston 410 may extend past a pump flange 310 or pump outlet 315 and into the filter element 50. An operator may choose to vary the speed and distance of piston 410 motion in order to optimize the formation of a cake from collected solids within the filter element 50 and to subsequently expel these solids through the filter end 330 or through a valve 340.

### 5) Operation

FIG. 6 illustrates the operation of filter system 10 which may be manually controlled by an operator or automatically controlled by a controller, e.g. controller 100, FIG. 2B. As discussed above, the incoming liquid-solid slurry 601 may include added chemistry that facilitates chemical liquid-solid separation. While it is contemplated that this chemistry has been added to the liquid-solid slurry 601 before the slurry reaches the filter system 10, separation chemistry may be added at various steps in the method 600 of operating the filter system 10 as shown in FIG. 6.

### a) Accepting and Directing Slurry

A first step 602 in operating the filter system 10 may be to accept incoming slurry in the collection vessel 20. In various embodiments, the operation of the collection vessels 20, dividers 220, and baffles 230 may enable the incoming slurry to flow in a continuous operation while regulating slurry flow to individual filter elements 50.

In various embodiments, during operation, clean liquid above the “water break” may be decanted in step 605 and transferred to a storage basin, released to the environment, separated in other types of mechanical separation systems, separated in similar filter units as described herein, or disposed of in an appropriate manner. Or some or all of the decanted liquid may be added to the incoming slurry at step 601 in order to re-use the separation chemistry within the decanted liquid or to optimize the separation process, such as by adding liquid to a slurry with a particularly high solid content. Those skilled in the art will recognize that the decanting steps, while not required for liquid-solid separation, offers various operational and process efficiencies. Such efficiencies may include eliminating the onsite sources of clean liquids for mixing separation chemistry or for optimizing the solid content of the slurry.

### b) Flow of Slurry to Filter Element

In step 606 regulator 30 may be opened to allow slurry to flow into the pump 40/filter element 50. In various embodiments as described herein, the regulator 30 may be a piston 410 that serves other functions as described herein. While FIG. 6 shows regulator 30 being opened after step 604 in which slurry is directed to filter elements 50, the regulator 30 may be opened before slurry is directed to the filter element in step 604. In step 608, the slurry is filtered in the filter element 50, causing liquid to escape through filter openings 320, and solids to collect within the filter element.

### c) Compacting Solids

In various embodiments, the solids collected within the filter element may be compacted in step 612. In order to compact the solids, the regulator 30 may be closed, as in step 610, in order to stop the flow of slurry to the filter element 50.

In some embodiments, the step of compaction 612 may be initiated before closing the regulator 30 in step 610. For example, as described above, in embodiments in which the piston 410 may also operate as a regulator. Operating the piston 410 may stop the flow of slurry to the filter element 50. In such an approach, when step 612 is initiated to compact the solids, and the operation of the piston 410 may thereby close the regulator 30, as in step 610, which may stop flow of slurry to the filter element.

In embodiments where the piston 410 may not be the regulator 30, those skilled in the art will recognize that operating the piston 410 to compact solids in step 612 may actuate step 610 through a variety of mechanical and electrical structures. For example, the operation of piston 410 in the compaction step 612 may trigger a switch or an electrical, optical, or magnetic sensor to close the regulator 30. Alternatively, the operation of piston 410 in step 612 may contact or actuate a mechanical linkage to close the regulator 30 in step 610.

In other embodiments, an operator may elect not to perform step 610 and may not close the regulator 30 to the filter element 50 during the compaction step 612.

### d) Desired Properties of Collected Solids

At decision point 614 the properties of the collected solids may be evaluated to determine if they meet the desired requirements. Such properties may include volume of collected solids, moisture content, or other factors. This may be done manually by an operator via, e.g. a “paint filter test” may be used to evaluate whether solids have reached a target moisture content. The paint filter test is one in which collected solids are placed on a paint filter element and observed for a period of time to determine whether water breaks from the collected solids. Those skilled in the art will be familiar with the paint filter test as applied at decision point 614. In the alternative, sensors may be used to detect the condition of the solids. Or, the system may be set to detect a predetermined pressure level in the compaction process and when detected terminate the compaction process. The predetermined pressure level may be set based empirical data which achieves a certain desired condition based on the composition of the solids.

### e) Repeated Steps

If, at decision point 614, it is determined that the collected solids are not as desired, the piston may be retracted and the system may revert to either step 615 to continue further filtering or to step 616 institute further compaction and subsequent steps.

If, at decision point 614 it is determined that the properties of the solids collected in the filter element 50 are as desired, then the system proceeds to step 617 and the pump 40 expels the solids in step 618. In such an operation, step 618 may be a continuation of the compaction stroke of piston 410 as shown in step 612.

In embodiments of filter element 50 with an open end 330, expelling the solids 618 may include operating piston 410, as actuated by actuator 430 through connecting rod 420, for a sufficient distance through the filter element 50 so as to expel the majority of the solids collected therein. For example, the expulsion step 618 may require moving piston 410 through the entire filter element 50 so that the piston 410 reaches the filter end 330.

In embodiments of filter element 50 with a valve 340 at the end, step 618 of expelling solids may include the added step of opening the valve 340 at the end of the filter element. In some embodiments, the valve 340 may be operated by force applied by the piston 410, the piston 410 potentially acting through the collected solids pressing on the valve. In other embodiments the opening and closing of the valve 340 may be automatic. For example, an operator may employ electrical, magnetic, optical, or mechanical position sensors and may open and close the valve 340 based upon the position of the piston 410 within the filter element 50. In various embodiments, the expulsion step 618 concludes with the operator retracting the piston 410.

In step 624, the separated solids and liquids may be disposed of. In FIG. 6 step 624 is shown after decision point 620; however, the solids may be disposed of in step 624 after the solids have been expelled 618 from the filter element 50 or at any point in time thereafter. Separated liquids may be stored, re-used, returned to the environment, or disposed of at any point in time.

### f) Continued Operation

At decision point 620 if additional slurry needs to be processed, in step 622 the operator retracts the piston 410 and repeats steps 602 through 618 as discussed herein. However, if there is no additional slurry to process, the remaining solids 624 and end operation 625 of the filter system 10.

While the present disclosure has been described with particular reference to certain embodiments of the system and method for separating solids from a liquid-solid slurry, it is to be understood that it includes all reasonable equivalents thereof as defined by the following appended claims.

g) Pumps that May not Require Regulators

In various embodiments employing pumps 40 that may not require regulators 30 to control slurry flow into the pump 40, operation as shown in FIG. 6 may differ, primarily in operation of the regulator 30 in steps 606 and 610 and in the decision point 614. First, unregulated pumps 40 may not require an operator to perform steps 606 and 610 to open and close the regulator 30 respectively. Second, pumps other than piston pumps may not allow an operator to perform decision point 614 and to determine whether the volume or moisture content of the collected solids may be as desired. Step 615 may be superfluous, because an operator may not perform step 606 and open the regulator 30 to the filter element 50, as there may be no regulator 30. Also, an operator may not perform step 616 and perform the compaction step 612. Instead, the pump 40 may push slurry into the filter element 50 and the solids that may collect may be expelled at whatever moisture content they reach if those solids progress to the filter end 330 as in step 618. In embodiments that may include a valve 340 at the end of the filter element 50, step 618 may require sufficient force from the pump 40 to operate the valve 340 or a separate actuation of the valve 340.

In embodiments with a diaphragm pump 40, step 606 may be unnecessary, because the regulator 30 may include a one-way valve that may allow slurry to flow through the pump inlet 300 during the pump 40 intake cycle.

The systems and methods described above are set forth by way of example and not of limitation. Numerous variations, additions, omissions, and other modifications will be apparent to one of ordinary skill in the art. Furthermore, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made without departing from the spirit and scope of this disclosure and all reasonable equivalents thereof as defined by the following appended claims.

1. A system for separating solids from a liquid-solid slurry, comprising:
A collection vessel having a first opening and at least one second opening positioned below the first opening, the collection vessel configured to receive the liquid-solid slurry through the first opening and to discharge the liquid-solid slurry through the at least one second opening;
At least one filter unit having a chamber with a first end, a second end, and a filter surface between the first end and the second end of the chamber, the filter surface having a plurality of apertures, the second end of the chamber having a discharge port; and
At least one pump unit interconnected to the first end of the chamber of the at least one filter unit;
Wherein one of the at least one filter unit or the at least one pump unit is in fluid communication with the at least one second opening in the collection vessel and is configured to receive the liquid-solid slurry from the at least one second opening and direct a flow of the liquid-solid slurry through the filter unit chamber, causing liquid from the liquid-solid slurry to flow through the apertures and out of the chamber of the filter unit and causing solids from the liquid-solid slurry to be retained in the chamber of the filter unit;
Wherein the at least one pump unit includes a discharge device which is translatable from the first end to the second end of the chamber of the filter unit to force solids retained in the chamber toward the discharge port.

2. The system of claim 1 wherein the collection vessel includes a top portion, a bottom portion, a first end portion and a second end portion and wherein the first opening is in the top portion and the at least one second opening is in the bottom portion.

3. The system of claim 2 wherein the collection vessel includes a plurality of collection sections distributed from the first end portion to the second end portion and wherein the collection sections are separated by dividers.

4. The system of claim 3 wherein each of the dividers comprises a baffle.

5. The system of claim 3 where each collection section of the collection vessel includes a second opening through which the liquid-solid slurry is discharged.

6. The system of claim 5 including a plurality of filter units and a like plurality of pump units one connected to each of the plurality of filter units, wherein one of each of the plurality of filter units or its pump unit is connected to one of the second openings in the collection sections.

7. The system of claim 6 including a flow regulator in fluid communication with each of the second openings in the collection sections to regulate flow of the liquid-slurry discharged from each of the second openings.

8. The system of claim 6 wherein each of the plurality of filter units includes a valve at the discharge port of the filter unit and wherein the valve may be selectively opened and closed to allow or disallow solids retained in the chamber to be discharged out of the discharge port.

9. The system of claim 8 wherein, in a compression mode, for each of the plurality of filter units the valve at the discharge port of the filter unit is closed and the discharge device is activated to translate toward the second end of the chamber to compress the solids in the chamber against the closed valve and force out retained liquid from the solids.

10. The system of claim 8 wherein each of the valves includes a door which is pivotably mounted to the chamber at the discharge port so that when the solids retained in the chamber are forced against the door by the discharge device as it is translates from the first end to the second end of the chamber the door is opened; and wherein each door includes a spring affixed to the door and to the filter unit proximate the discharge port which expands when the door is opened as the discharge device forces solids out of the discharge port and when the solids are discharged and when the discharge device retracts the spring retracts and causes the door to close.

11. The system of claim 6 wherein each pump includes a pump inlet connected to the second opening to receive the flow of the liquid-solid slurry from a respective collection section.

12. The system of claim 11 wherein each pump includes a pump cavity interconnected to the pump inlet, and wherein the pump cavity is interconnected to the filter chamber so as to allow the flow of liquid-solid slurry to pass through the pump cavity and into the filter chamber.

13. The system of claim 12 wherein the discharge device includes a piston and an actuator to extend and retract the piston; wherein when the piston is in a retracted position it is located in the pump cavity and when it is activated to extend it translates through the pump cavity and into the filter chamber to cause a surface of the piston to force solids retained in the chamber out of the discharge port.

14. The system of claim 13 wherein when the piston is activated to extend from the pump cavity to the filter chamber, the piston blocks the pump inlet thereby preventing the flow of the liquid-slurry discharge until after the piston is retracted and is no longer blocking the pump inlet.

15. The system of claim 6 wherein the chamber of each filter unit has a quadrilateral cross-section.

16. The system of claim 15 wherein the apertures in each filter unit are disposed in each of four sides of the chamber and the apertures each have a length substantially greater than its width.

17. The system of claim 1 wherein the at least one filter unit includes a liquid collection vessel to collect the liquid from the liquid-solid slurry which flows through the apertures; and there is further included a conduit in communication with the liquid collection vessel and configured to direct liquid from the liquid collection to the first opening in the collection vessel for further filtration.

18. A method for separating solids from a liquid-solid slurry, comprising:
Introducing a liquid-solid slurry into a collection vessel through a first opening and discharging the liquid-solid slurry through at least one second opening positioned below the first opening;
Providing at least one filter unit having a chamber with a first end, a second end, and a filter surface between the first end and the second end of the chamber, the filter surface having a plurality of apertures, the second end of the chamber having a discharge port;
Providing at least one pump unit interconnected to the first end of the chamber of the at least one filter unit;
Receiving the liquid-solid slurry from the at least one second opening by the at least one filter unit or the at least one pump unit and directing a flow of the liquid-solid slurry through the filter unit chamber to cause liquid from the liquid-solid slurry to flow through the apertures and out of the chamber of the filter unit and to cause solids from the liquid-solid slurry to be retained in the chamber of the filter unit; and
Forcing solids retained in the chamber toward the discharge port using a discharge device which is part of the at least one pump unit, wherein the discharge device is translatable from the first end to the second end of the chamber of the filter unit.

19. The method of claim 18 wherein the collection vessel includes a top portion, a bottom portion, a first end portion and a second end portion and wherein the first opening is in the top portion and the at least one second opening is in the bottom portion.

20. The method of claim 19 wherein providing the collection vessel includes providing a plurality of collection sections distributed from the first end portion to the second end portion and wherein the collection sections are separated by dividers.

21. The method of claim 20 wherein providing the plurality of collection sections includes providing each of the dividers with a baffle.

22. The method of claim 20 wherein providing the plurality of collection sections includes providing each collection section with a second opening through which the liquid-solid slurry is discharged.

23. The method of claim 22 includes providing a plurality of filter units and a like plurality of pump units one connected to each of the plurality of filter units, wherein one of each of the plurality of filter units or its pump unit is connected to one of the second openings in the collection sections.

24. The method of claim 23 includes regulating a flow of the liquid-slurry discharged from each of the second openings using a regulator in fluid communication with each of the second openings in the collection sections.

25. The method of claim 23 includes providing each of the plurality of filter units with a valve at the discharge port of the filter unit and selectively opening and closing the valve to allow or disallow solids retained in the chamber to be discharged out of the discharge port.

26. The method of claim 25 includes closing, in a compression mode, the valve at the discharge port of each of the filter units and translating the discharge device toward the second end of the chamber to compress the solids in the chamber against the closed valve and force out retained liquid from the solids.

27. The method of claim 25 includes providing each of the valves with a door pivotably mounted to the chamber at the discharge port, translating the discharge device from the first end to the second end of the chamber to force the solids retained in the chamber against the door, causing the door to open and a spring affixed to the door and to the filter unit proximate the discharge port to expand and when the discharge device forces solids out of the discharge port retracting the discharge device causing the spring to retract and close the door.

28. The method of claim 23 includes providing each pump with a pump inlet connected to the second opening to receive the flow of the liquid-solid slurry from a respective collection section.

29. The method of claim 28 includes providing each pump with a pump cavity interconnected to the pump inlet, and connecting the pump cavity to the filter chamber so as to allow the flow of liquid-solid slurry to pass through the pump cavity and into the filter chamber.

30. The method of claim 29 includes providing the discharge device with a piston and an actuator to extend and retract the piston; wherein when the piston is in a retracted position it is located in the pump cavity and when it is activated to extend it translates through the pump cavity and into the filter chamber to cause a surface of the piston to force solids retained in the chamber out of the discharge port.

31. The method of claim 30 includes extending the piston from the pump cavity to the filter chamber, and causing the piston to block the pump inlet thereby preventing the flow of the liquid-slurry discharge until after the piston is retracted and is no longer blocking the pump inlet.

32. The method of claim 23 wherein the chamber of each filter unit has a quadrilateral cross-section.

33. The method of claim 18 includes disposing the apertures in each filter unit in each of four sides of the chamber and providing the apertures with a length substantially greater than its width.

34. The method of claim 18 wherein providing the at least one filter unit includes providing a liquid collection vessel to collect the liquid from the liquid-solid slurry which flows through the apertures; and further providing a conduit in communication with the liquid collection vessel to direct liquid from the liquid collection to the first opening in the collection vessel for further filtration.
